(19) United States
(12) Patent Application Publication
(10) Pub. No.: US 2011/0256381 A1
(43) Pub. Date: Oct. 20, 2011

(54) ENERGY EFFICIENT ROOF COVERING

(76) Inventor: James Anthony Shula, Sylvania, OH (US)

(21) Appl. No.: 13/085,550

(22) Filed: Apr. 13, 2011

Related U.S. Application Data
(60) Provisional application No. 61/324,470, filed on Apr. 15, 2010.

(51) Int. Cl. G02F 1/00; B32B 5/16

(52) U.S. Cl. 428/323; 252/583

(57) ABSTRACT

A roofing for residential and commercial buildings is disclosed, the roofing including a base for application to a building roof structure and exposed to the atmosphere, and a reflective material disposed on the base, a color of the reflective material being changeable upon excitation by solar energy.

### CROSS-REFERENCE TO RELATED APPLICATION

This application claims the benefit of priority of U.S. Provisional Patent Application Serial No. 61/324,470 filed on Apr. 15, 2010 hereby incorporated herein by reference in its entirety.

### FIELD OF THE INVENTION

The present invention relates to roofing materials and more specifically to roof covering for residential and commercial buildings which changes color to vary the solar reflectivity of the associated roof.

### BACKGROUND OF THE INVENTION

The ever increasing consumption of energy to cool buildings, coupled with global and regional environmental warming issues, has caused a conversion in contemporary roofing technologies to roofing with more reflective top surfaces so that the roofing better reflects solar radiation to thereby reduce the amount of solar radiation absorbed by the roofing and the amount of energy required to cool buildings. Contemporary roofing technologies typically increase the reflectivity of the top surface of the roofing by making the top surface (the exposed surface) of the roofing white. Architects have traditionally specified light surface colors to cool off buildings in hot climates, but until recently there has been little research on the measured cooling-energy savings of reflective roofs. Recently, researchers have examined the impact of reflective roof coatings on air-conditioning energy use in retrofits of monitored buildings.

Due to their irregular granular top surfaces and the intergranular spaces that reveal the black light-absorbing asphalt surfaces to which the granules are adhered, asphalt-based waterproof roofing membranes, such as cap sheets, currently on the market do not meet EPA Energy Star reflective requirements as measured by ASTM standard E-903—Standard Test Method for Solar Absorptance, Reflectance, and Transmission of Materials Using Integrating Spheres. The current technology used at the job site to upgrade asphalt-based waterproof roofing membranes and provide these roofing membranes with more reflective top surfaces involves covering the exposed surfaces of the roofing membranes with a reflective coating at the job site. This procedure leads to several problems: a waiting period of up to 30 days before the coating can be applied to the top surface of the membrane; the cost of and time required to clean the top surface of the membrane before applying the coating to the top surface of the membrane; the cost of and time involved in the labor intensive application of the coating to the top surface of the membrane; the quality and/or consistency of the application of the coating to the top surface of the membrane which is dependent on the skill and conscientiousness of the laborer; the limited service life of such coatings on the top surface of the membrane; and the requirement of periodic maintenance and reapplication of the coating to the top surface of the membrane. The problems associated with applying white coatings at the job site to the top surfaces of asphalt-based waterproof roofing membranes, plus the ease with which single-ply roofing membranes, such as polyvinyl chloride and thermoplastic olefin single-ply roofing membranes, can be made from white compounds, have contributed to market shifts away from multi-ply asphalt-based commercial roofing systems to single-ply membrane roofing systems.

It has been discovered that reflective roofs can reduce space cooling energy consumption based on data collected so far that suggests that air conditioning savings of 10-40% can be realized, with greater savings in more efficiently thermally retrofitted buildings. For new homes, it is possible to choose roofing types, such as metal roofing, tile roofing, or metal or ceramic shingles that can be specified in reflective white in color. Unfortunately, no truly reflective asphalt roofing shingles yet exist for the residential market. For commercial buildings, a variety of reflective roofing materials are available such as, for example, synthetic rubbers, white EPDM, and PVC single-ply membranes.

Roofs having a light color absorb only a small amount of solar energy and consequently convert a minimal amount of the impinging electromagnetic energy spectrum into heat and are therefore deemed to be very energy efficient during the warm and hot months of the year. During the cool and cold months of the year, it has been found that dark color roofs, such as typical tar and fiberglass paper backed shingles, are the most energy efficient. When solar energy in the form of light impinges on roofs which are dark in color, a great percentage of the impinging energy is absorbed and converted into heat energy. Very little energy is reflected away from the roof. A dark color roof absorbs most of the light energy that impinges upon it, causing the surface to heat up quickly.

Black or dark colored materials and objects give off and absorb heat the fastest. Instead of thinking of dark colors as absorbers of heat, darker colors are actually better absorbers of light. Darker colors absorb comparatively more light. Since light is energy, an absorption would increase a temperature of a material. Hence, darker colors become better radiators of heat.

It is important to note that an object appears white if it reflects all colors and black if it absorbs all colors. Naturally there are different degrees of color and therefore degrees of absorption. So, too, the type of material will affect its relative heating. An object with a dull black (non-reflective) finish will absorb the most energy and reflect the least.

When a black object is illuminated by white light, all wavelengths are absorbed and none are reflected. As a result, the object appears black when we look at it. When light is absorbed by a black object, the energy carried by the light doesn't just disappear. It raises the energy of the object that absorbs the light. The object, in turn, releases the absorbed energy from light by emitting longer wavelength, lower energy infrared (heat).

This transformation of light into heat is important because it accounts for the law of conservation of energy. Light does not disappear when it strikes a black object. Instead, light is transformed into another kind of radiation that is either radiated from or retained within the black object. The darker the object, the better its emission of heat because it absorbs light better.

It would be desirous to produce a roofing material which will change color when exposed to a change in temperature and thereby changing the reflectivity of the roofing material.

### SUMMARY OF THE INVENTION

Concordant and congruous with the present invention, a roofing material which will change color when exposed to a change in temperature and thereby changing the reflectivity of the roofing material has surprisingly been discovered.

According to an embodiment of the invention, a roofing for residential and commercial buildings comprises a base for application to a building roof structure and exposed to the atmosphere; and a reflective material disposed on the base, a color of the reflective material being changeable upon excitation by solar energy.

According to another embodiment of the invention, a roofing for residential and commercial buildings comprises a base for application to a building roof structure and exposed to the atmosphere; and a reflective material incorporated into the base, a color of the reflective material being changeable upon excitation by solar energy.

According to another embodiment of the invention, a roofing for residential and commercial buildings comprises a base for application to a building roof structure and exposed to the atmosphere; and a polymer layer having a reflective material incorporated into a matrix thereof disposed on the base, a color of the reflective material being changeable upon excitation by solar energy.

### DETAILED DESCRIPTION OF THE PREFERRED EMBODIMENT

In accordance with the objectives of the invention, a roofing for residential and commercial buildings is contemplated wherein color changeable roofing tiles and coatings will change color from dark to light and vice versa depending on outside temperatures to deflect or absorb heat as an energy savings method.

The roofing in accordance with the present invention may include tiles, shingles, membranes, etc. These may consist of a base for application to the roof surface to be roofed. The base may include metal roofing, tile roofing, metal, ceramic or asphalt shingles in the instance of residential buildings; and a variety of roofing for commercial buildings such as, for example, a chlorosulfonated polyethylene (sold under the trademark Hypalon® by DuPont Performance Elastomers), synthetic rubber, EPDM, and PVC single-ply membranes. One surface of the roofing base is in facing relation to the building and the opposite surface faces the atmosphere.

Incorporated within and distributed through the base is a reflective material. The reflectivity of the material is changeable upon excitation thereof by an energy, such as solar energy, for example. It is understood that the reflective material may be applied to the base, or the reflective layer may be applied on or incorporated into a layer that is subsequently applied to or incorporated into the base. Examples of substances which exhibit thermochromism (the ability of substances to change color due to a change in temperature) that may be used as the reflective material are liquid crystals and leuco dyes. Leuco dyes include: the Spiro form of an oxazine (a colorless leuco dye) and crystal violet lactone which in its lactone form is colorless or slightly yellowish but, when protonated, becomes intensely violet in color. Other thermochromic substances include: inks or dyes; paints; spiropyrans; spirooxazines; diarylethenes; azobenzenes; quinones, such as phenoxynaphthacene quinone; zinc oxide; cuprous mercury iodide (Cu₂H_{g}I₄); nickel sulfate, 2,3,4,4-tetrachloronaphthalen-1 (4H); and vanadium dioxide. Other thermochromic substances include some chromium-rich pyropes. Other suitable thermochromic materials include liquid crystals, such as cholesteryl nonanoate or cyanobiphenyls, for example. The liquid crystals may be microencapsulated in the form of a suspension, as desired.

The thermochromic substance of the reflective material may be selected based on desired light colors at cooler temperatures and desired dark colors at warmer temperatures. For example, vanadium dioxide doped with 1.9% of tungsten undergoes a phase transition that alters its color from a temperature transmissive phase (e.g., a semiconductor) at lower temperatures to a reflective conductive phase at higher temperatures at about 84° F. Similarly, organic leuco dyes have phase transition temperatures in temperature ranges between about 23° F. and about 140° F.

It will be appreciated that roofing produced in accordance with the invention is energy efficient compared to standard residential roofing. By maximizing energy efficiency, energy costs to cool in the summer are minimized and energy costs to heat in the winter months are minimized.

In another embodiment of the invention, the reflective material is a polymer layer having one of the dyes, inks, liquid crystals, etc. listed hereinabove incorporated into a matrix thereof. The polymer layer is then incorporated into, adhered to, or otherwise fixed to the base layer. The polymer layer may include a stabilizer to beneficially prolong a useful life thereof. The polymer layer may also include a barrier layer. The barrier layer may be an oxygen barrier layer or other chemical barrier layer to prolong the useful life of the polymer layer. Suitable oxygen barriers include: transparent ceramic barriers (such as the barrier film sold under the Escal™ trademark by KeepSafe Microclimate Systems of Toronto, Ontario, Canada), sputtered aluminum, EVOH, and a nylon. An outer barrier layer of Escal™ barriers is polypropylene while an inner barrier layer is a vacuum-deposited ceramic on a PVA substrate. The glass-like inner barrier layer offers nearly the same barrier capacity as aluminum foil based films. Oxygen permeability is 0.05 cc/m2/24 hrs, water vapor transmission is 0.01 gm/m2/24 hrs. As in most sealable barrier films, an inner layer of Escal™ barriers is polyethylene.

It will be appreciated that roofing produced in accordance with the invention is energy efficient compared to standard residential roofing. By maximizing energy efficiency, energy costs to cool in the summer are minimized and energy costs to heat in the winter months are minimized.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A roofing for residential and commercial buildings comprising:
a base for application to a building roof structure and exposed to the atmosphere; and
a reflective material disposed on the base, a color of the reflective material being changeable upon excitation by solar energy.

2. The roofing of claim 1, wherein the reflective material is incorporated into the base.

3. The roofing of claim 1, wherein the reflective material is a thermochromic substance.

4. The roofing of claim 3, wherein the reflective material is a leuco dye.

5. The roofing of claim 4, wherein the leuco dye is an organic leuco dye having a phase transition temperature in a range from between about 23° F. to about 140° F.

6. The roofing of claim 3, wherein the reflective material is a liquid crystal.

7. The roofing of claim 6, wherein the liquid crystal is microencapsulated in the form of a suspension.

8. The roofing of claim 3, wherein the liquid crystal is one of cholesteryl nonanoate and cyanobiphenyls.

9. The roofing of claim 3, wherein the thermochromic substance is incorporated into a matrix of a polymer layer.

10. The roofing of claim 9, wherein the polymer is incorporated into the base.

11. The roofing of claim 9, wherein the polymer layer is adhered to the base.

12. The roofing of claim 9, wherein the polymer layer includes a barrier layer.

13. The roofing of claim 12, wherein the barrier layer is an oxygen barrier layer.

14. The roofing of claim 13, wherein the barrier layer is a transparent ceramic barrier, EVOH, and a nylon.

15. The roofing of claim 1, wherein the reflective material is vanadium dioxide doped with 1.9% of tungsten.

16. A roofing for residential and commercial buildings comprising:
a base for application to a building roof structure and exposed to the atmosphere; and
a reflective material incorporated into the base, a color of the reflective material being changeable upon excitation by solar energy.

17. The roofing of claim 16, wherein the reflective material is a thermochromic substance.

18. The roofing of claim 17, wherein the reflective material is a leuco dye.

19. The roofing of claim 16, wherein the reflective material is a liquid crystal.

20. A roofing for residential and commercial buildings comprising:
a base for application to a building roof structure and exposed to the atmosphere; and
a polymer layer having a reflective material incorporated into a matrix thereof disposed on the base, a color of the reflective material being changeable upon excitation by solar energy.
